(19) United States
(12) Patent Application Publication
(10) Pub. No.: US 2008/0301282 A1
(43) Pub. Date: Dec. 4, 2008

(54) Systems and Methods for Storing Interaction Data

(75) Inventor: Mark Edmund Coleman, East Setauket, NY (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: VERNIT AMERICAS, INC., Melville, NY (US)

(21) Appl. No.: 11/776,659

(22) Filed: Jul. 12, 2007

Related U.S. Application Data
(60) Provisional application No. 60/940,803, filed on May 30, 2007.

(51) Int. Cl. G06F 15/173; H04M 1/65

(52) U.S. Cl. 709/224; 379/265.06; 379/88.22

(57) ABSTRACT

A method for storing customer center communications data includes receiving communications data at a host, wherein the communications data corresponds to a communication involving a customer center agent at a customer center located remotely from the host, storing the communications data at the host, and providing the communications data to a device located at the customer center.

### CROSS REFERENCE

This application claims the benefit of U.S. Provisional Application Ser. No. 60/940,803, filed May 30, 2007, which is hereby incorporated by reference in its entirety.

### TECHNICAL FIELD

The present disclosure generally relates to the storage of communications data.

### BACKGROUND

In many customer centers, one or more customers and/or potential customers may initiate a telephone call, web chat, text message, email, etc. for communicating with the customer center. In facilitating this communication, the customer center may be staffed by agents who handle incoming and/or outgoing customer center interactions. Similarly, a customer center may include an agent communication device and/or an agent computing device. A network may be included and configured to communicatively connect one or more of the agent computing devices.

Additionally, customer centers may record interactions between the agent and customer, as well as data indicating information that is accessed and/or entered by the agent during the communication. However, the equipment and software used to record communications data is relatively expensive and requires expert implementation and administration.

### SUMMARY

A method for storing customer center communications data includes receiving communications data at a host, wherein the communications data corresponds to a communication involving a customer center agent at a customer center located remotely from the host, storing the communications data at the host, and providing the communications data to a device located at the customer center.

Also included are embodiments of a system that includes memory, software stored in the memory, and a processor. At least one embodiment includes the logic is configured to instruct the processor to cause communications data to be stored at the host, wherein the communications data corresponds to a communication involving a customer center agent at a customer center located remotely from the host. Similarly, in some embodiments, the logic is configured to instruct the processor to cause the communications data to be delivered to a device located at the customer center.

Also included are embodiments of a computer readable storage medium for storing customer center communications data. At least one embodiment includes logic configured to receive communications data at a host, wherein the communications data corresponds to a communication involving a customer center agent at a customer center located remotely from the host, wherein the communications data includes audio data and visual data. Similarly, some embodiments include logic configured to record the audio data at the host and logic configured to provide the audio data to a device located at the customer center. Some embodiments include logic configured to record, at the host, the visual data and logic configured to correlate the visual data with the audio data.

Other systems, methods, features, and advantages will be or become apparent to one with skill in the art upon examination of the following drawings and detailed description. It is intended that all such additional systems, methods, features, and advantages be included within this description, be within the scope of the present disclosure.

### BRIEF DESCRIPTION

This disclosure can be better understood with reference to the following drawings. The components in the drawings are not necessarily to scale, emphasis instead being placed upon clearly illustrating the principles of the present disclosure. In the drawings, like reference numerals designate similar components throughout the several views.

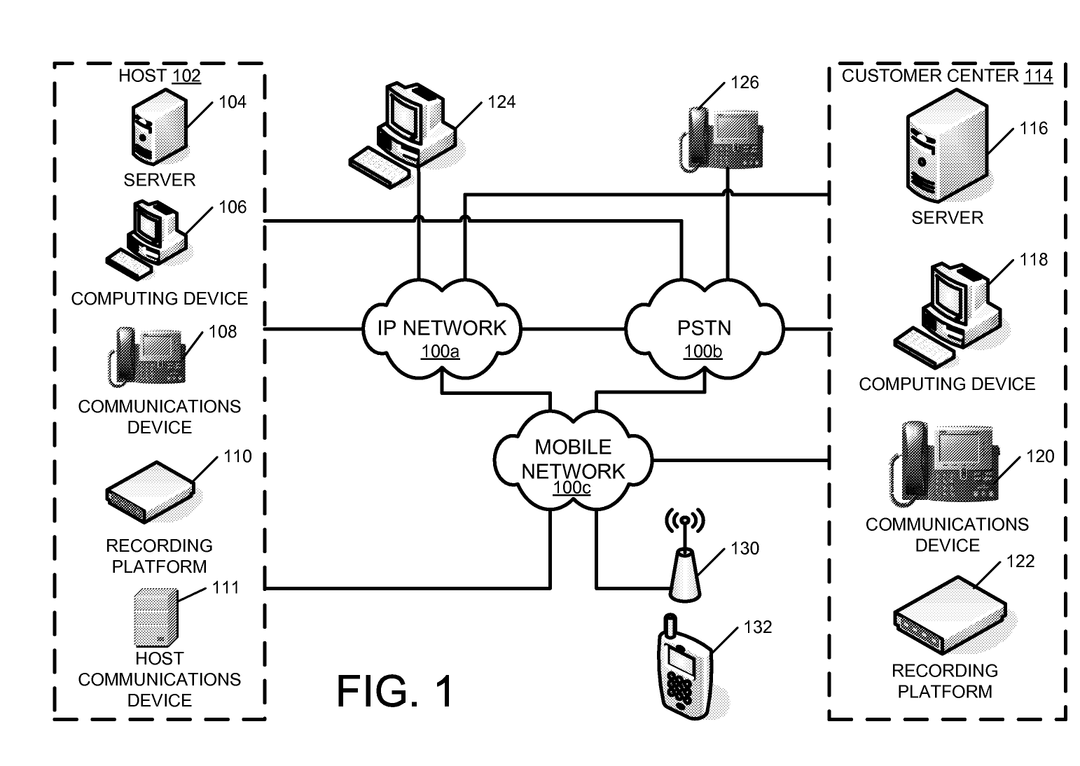

FIG. 1 is a schematic diagram of an exemplary embodiment of a network diagram, illustrating a host and a customer center.

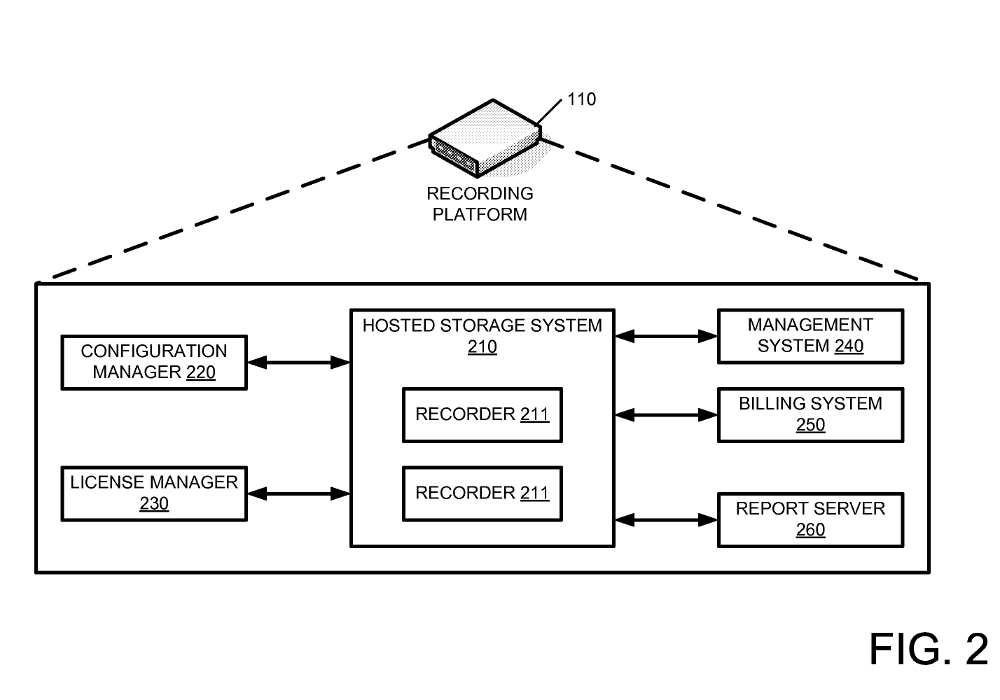

FIG. 2 is a schematic diagram of an exemplary embodiment, illustrating functional components that may be utilized in a recording platform, such as a recording platform from FIG. 1.

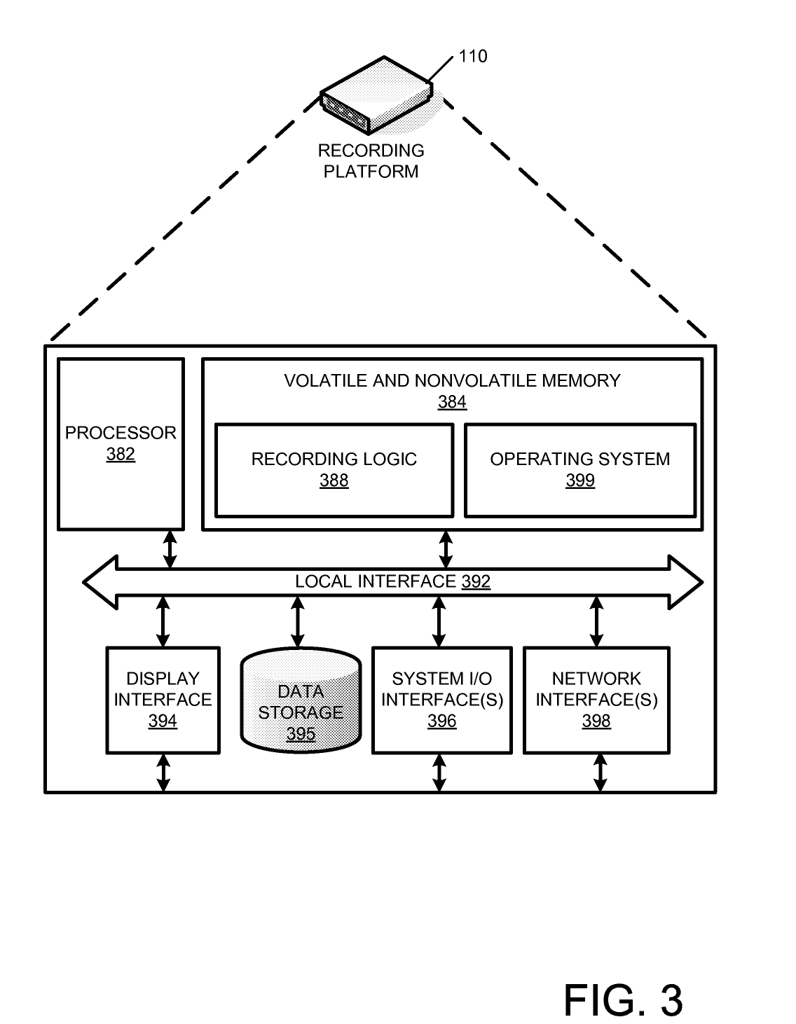

FIG. 3 is a schematic diagram of an additional exemplary embodiment of a recording platform, illustrating logical components that may be utilized.

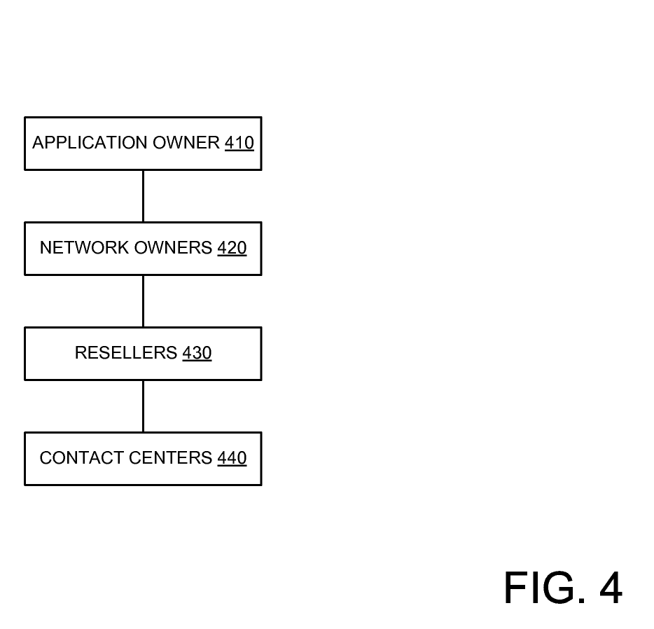

FIG. 4 is a schematic diagram of a diagram illustrating an exemplary embodiment of a multi-tiered service provider configuration, such as may be utilized in the network from FIG. 1.

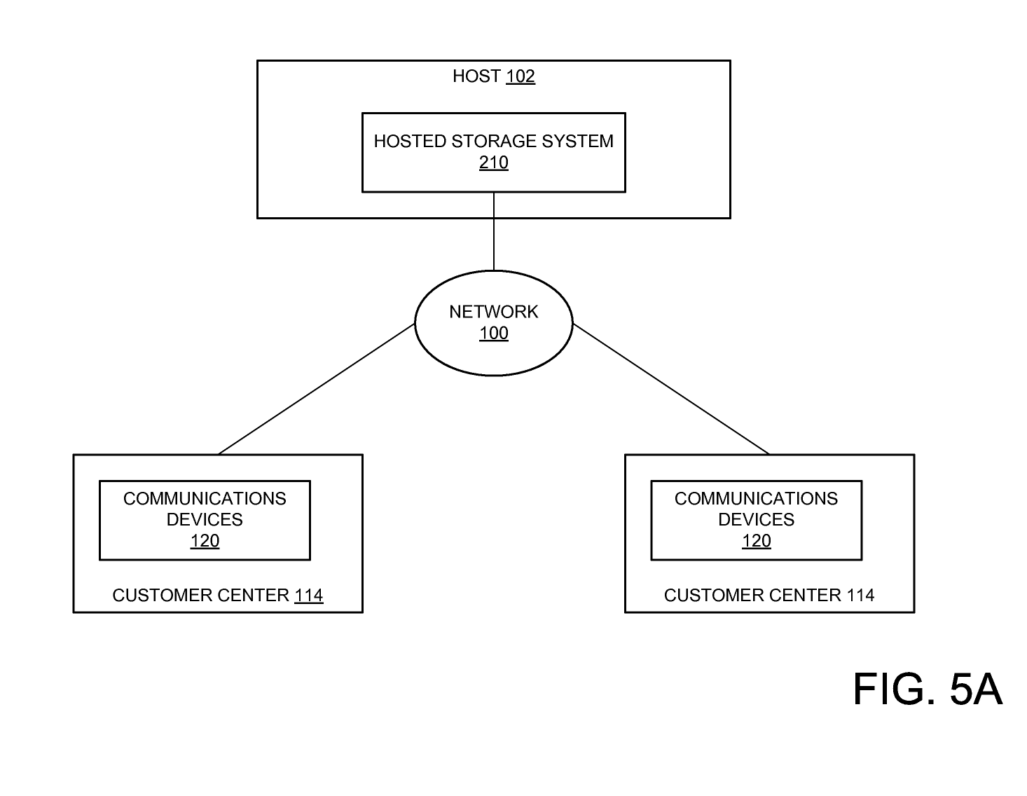

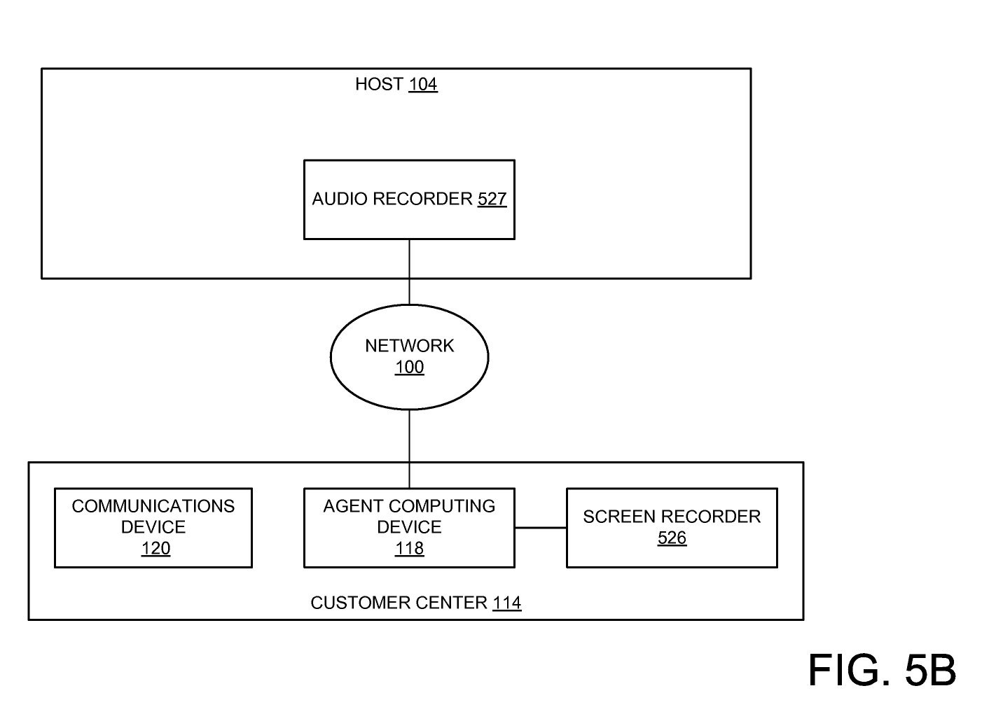

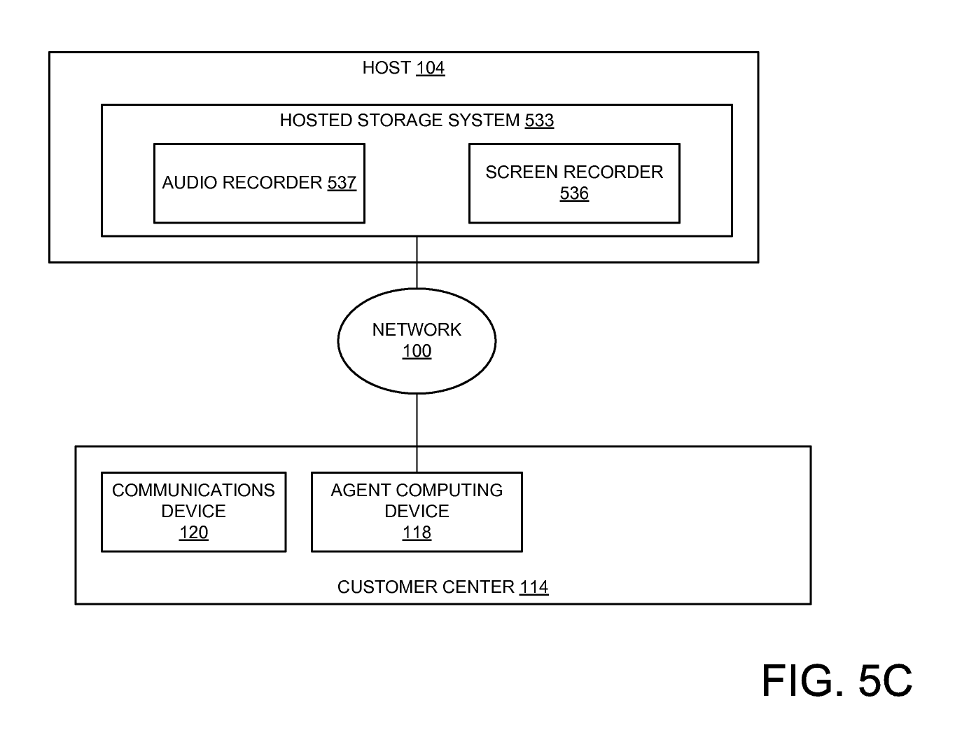

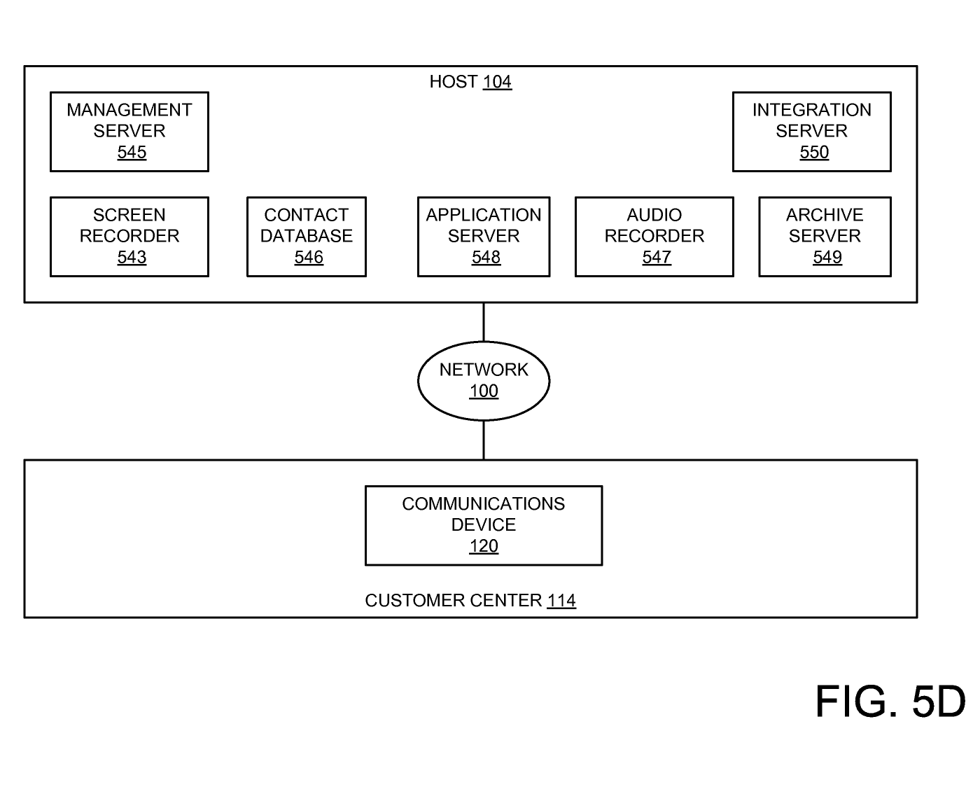

FIG. 5A is a schematic diagram of an exemplary embodiment of a network configuration, illustrating a distributed customer center configuration.

FIG. 5B is a schematic diagram of an exemplary embodiment of a network configuration, illustrating a distributed recording configuration.

FIG. 5C is a schematic diagram of an exemplary embodiment of a network configuration, illustrating a plurality of recording platforms at a host.

FIG. 5D is a schematic diagram of an exemplary embodiment of a network configuration, illustrating a plurality of server components at a host.

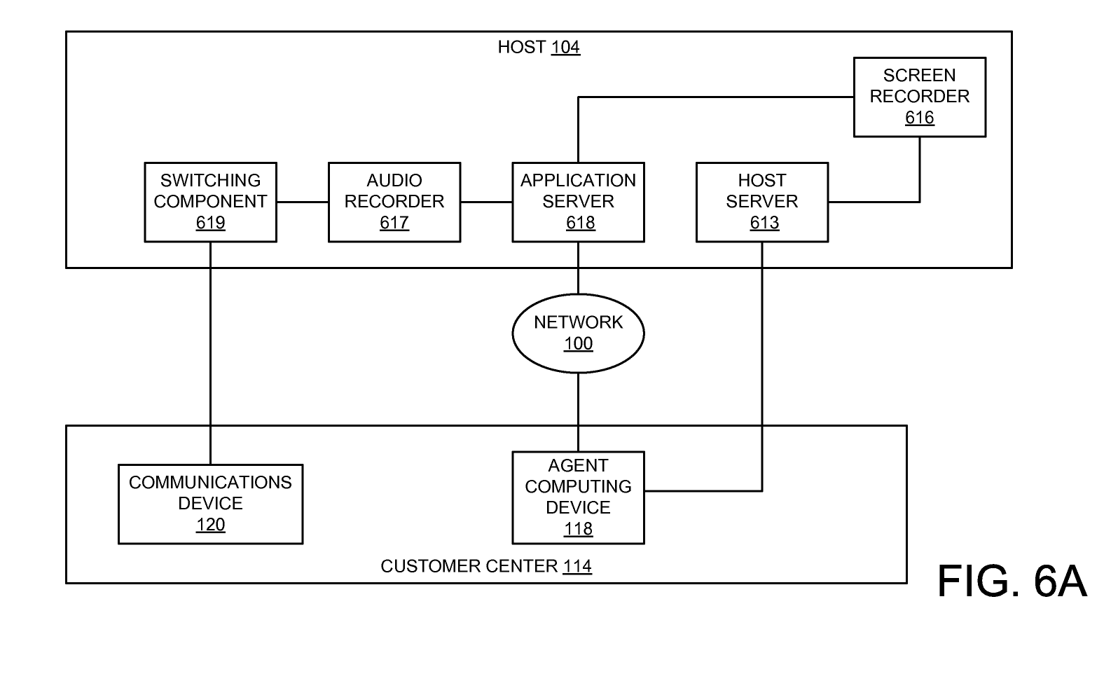

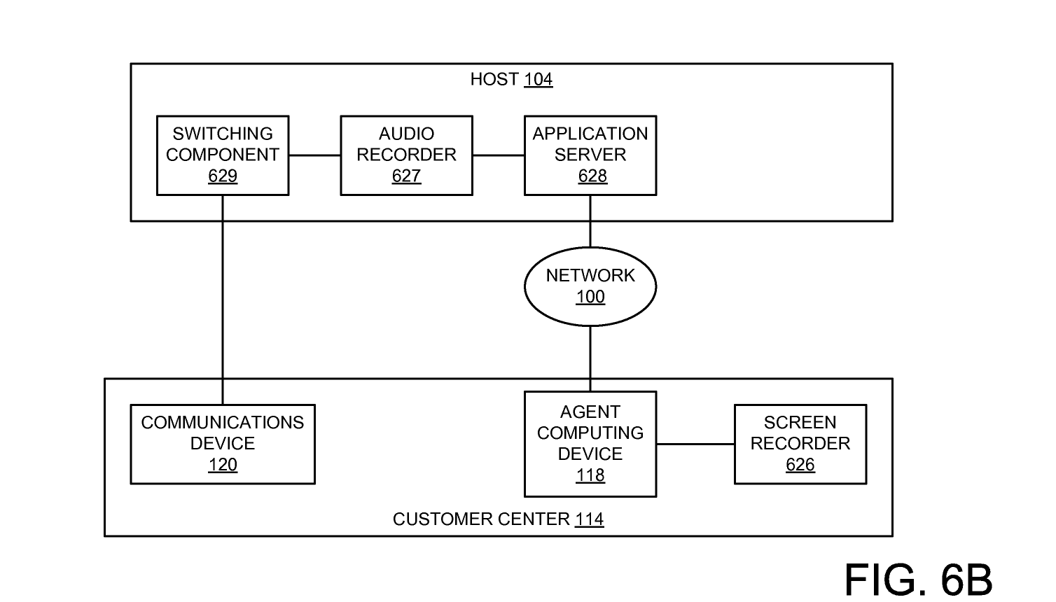

FIG. 6A is a schematic diagram of an exemplary embodiment of a network configuration, illustrating a plurality of connections between components of a host and a customer center.

FIG. 6B is a schematic diagram of an exemplary embodiment of a network configuration, illustrating a plurality of connections between components of a host and a customer center with a distributed recording architecture, similar to the diagram from FIG. 6A.

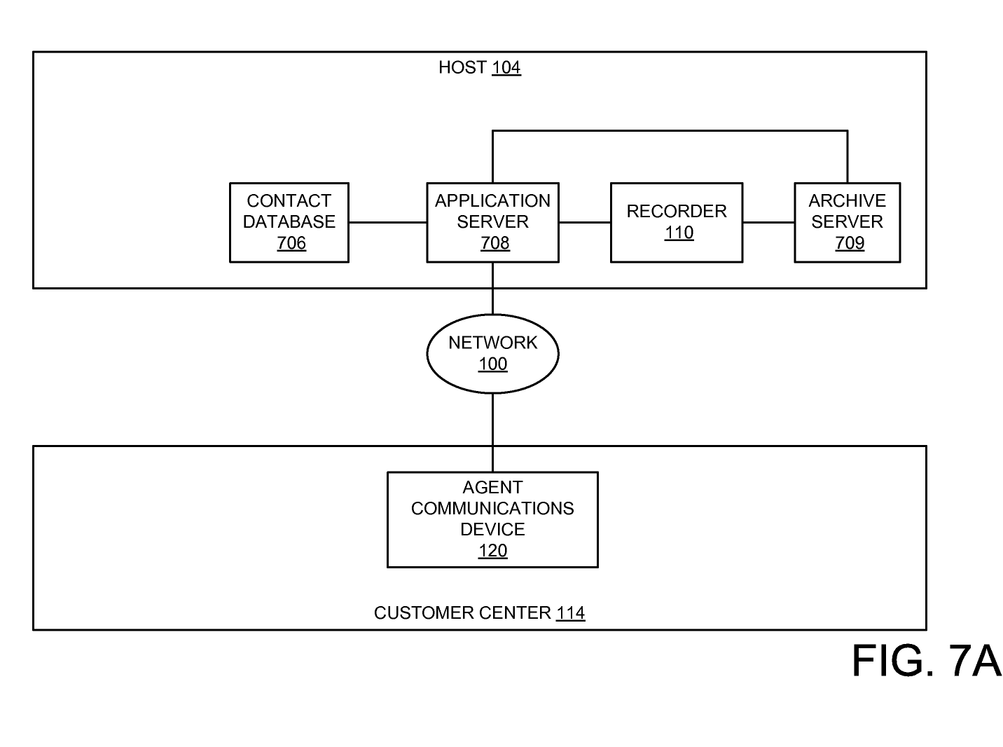

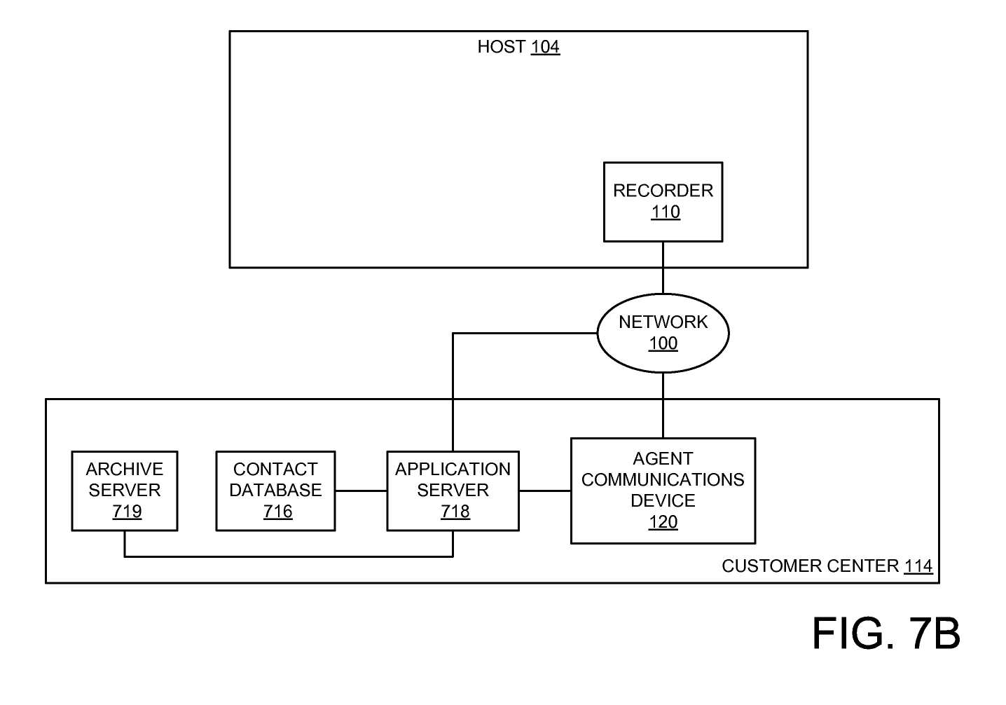

FIG. 7A is a schematic diagram of an exemplary embodiment of a network configuration, illustrating a plurality of connections between components of a host and a customer center, including a contact database.

FIG. 7B is a schematic diagram of an exemplary embodiment of a network configuration, illustrating a plurality of connections between components of a host and a customer center, including a contact database at a customer center.

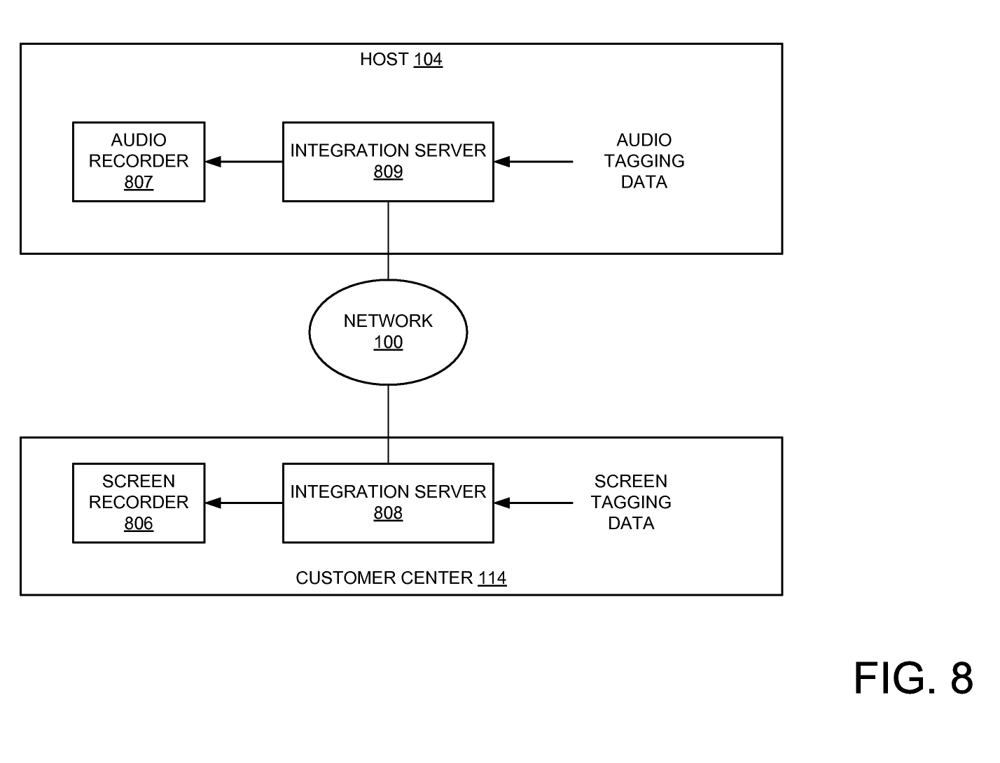

FIG. 8 is a schematic diagram of an exemplary embodiment of a network configuration, illustrating a plurality of integration servers in a distributed recording environment.

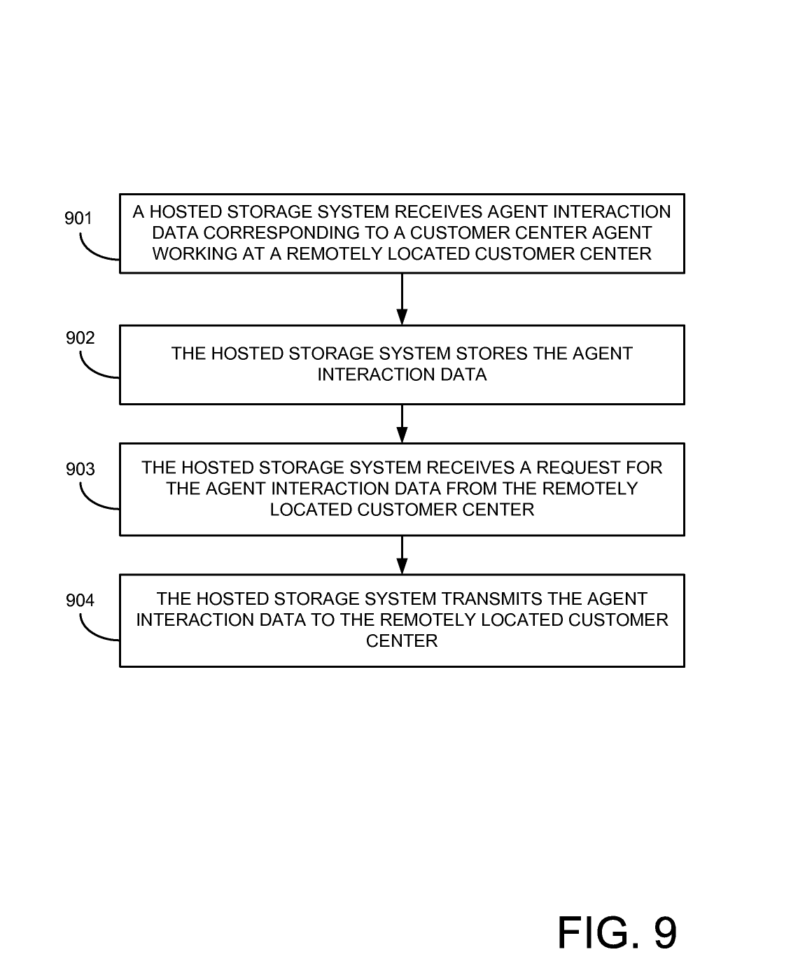

FIG. 9 is a flowchart illustrating an exemplary embodiment of a process that may be utilized for transmitting data to a customer center.

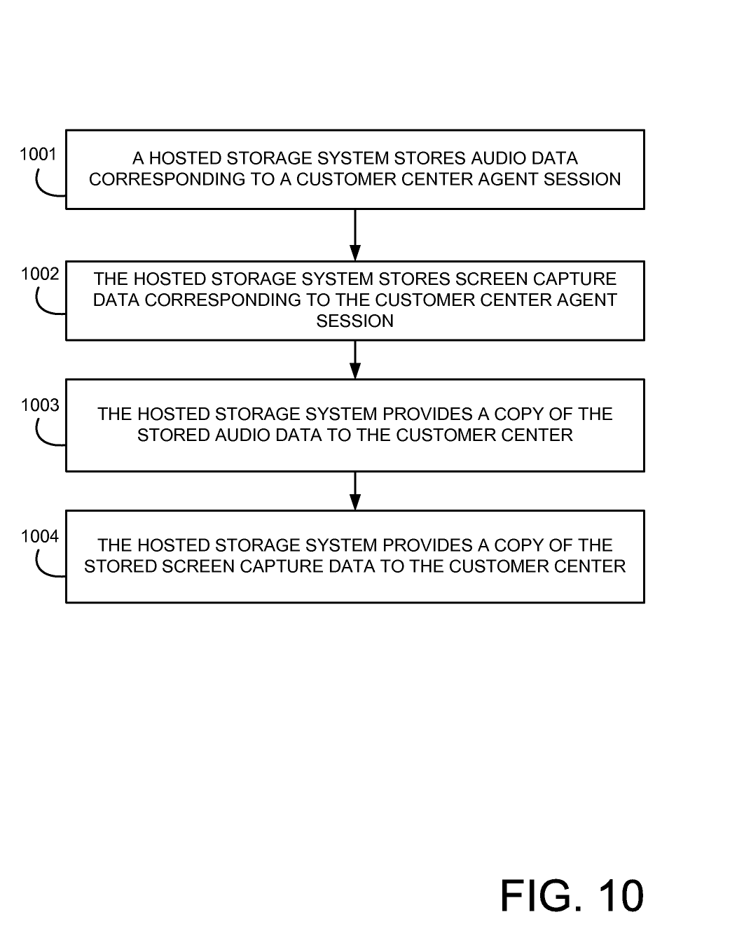

FIG. 10 is a flowchart illustrating an exemplary embodiment of a process that may be utilized for providing a copy of captured data to a customer center.

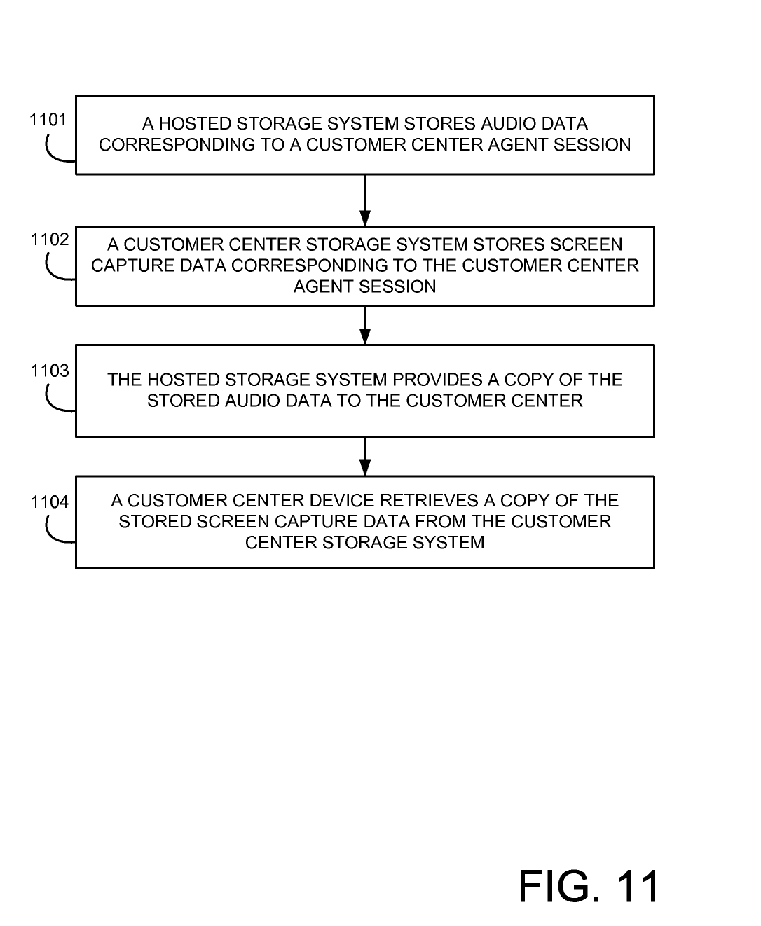

FIG. 11 is a flowchart illustrating an exemplary embodiment of a process that may be utilized for retrieving captured data from a customer center.

### DETAILED DESCRIPTION

Included herein are embodiments for providing data capture and storage to a customer center by a remotely located host. More specifically, in at least one embodiment, the host may be configured to receive and store communications data from one or more customer center to provide accessibility to the captured data. The host may be configured to receive and/or capture the communications data based on predetermined criteria. Additionally, the host may include a plurality of components for billing, reporting, licensing, etc. Other embodiments are also discussed below.

With reference to the drawings, FIG. 1 is an exemplary embodiment of a network diagram, illustrating a host and a customer center. As illustrated in the nonlimiting example of FIG. 1, one or more networks 100a, 100b, 100c may be included and configured to facilitate communication among network components. More specifically, an Internet Protocol (IP) network may be included and configured for Internet, Voice over IP (VoIP), and/or other communications. Also included is a Public Switched Telephone Network (PSTN) 100b, which may be configured for facilitating analog communications. A mobile network 100c may also be included and configured to facilitate mobile communications, such as cellular, Personal Communications Services (PCS) and/or other communications. Coupled to the communications network (referred to collectively as network 100), is a host 102. The host 102 may include a plurality of components, such as a server 104, a computing device 106 (which may be embodied in a server, and/or combined with the server 104), a communications device 108, a recording platform 110, and a host communications device 111 (which, in at least one nonlimiting example, may be embodied as a Private Branch Exchange (PBX). Also included is a customer center 114. The customer center 114 may also include a server 116, a computing device 118, a communications device 120 and a recording platform 122.

The IP network 100a may also be coupled to one or more computing devices 124. The PSTN 100b may be coupled to one or more communications devices 126. The mobile network may be coupled to one or more access points and/or communication towers 130, which may facilitate communication with one or more mobile communications device 132. Other variations of these devices may also be coupled the network 100.

In operation, a customer and/or potential customer may initiate a communication with a customer center 114. The customer center 114 may include an automated introduction, however this is not a requirement. Upon determining the desired destination for the customer, the customer center 114 may route the communication to that destination, which may be embodied in the computing device 118, the communications device 120, and/or the server 116. Additionally, when connected with a customer, a customer center 114 may be configured to record at least a portion of the communication, via the recording platform 122.

Additionally, depending on the particular configuration (and as discussed in more detail below), the host 102 may be configured as a remote network for facilitating communication and/or recording of data between one or more customer and one or more customer center 114.

One should note that while the host 102 and the customer center 114 are each illustrated with certain components, the host 102 and the customer center 114 are illustrated in FIG. 1 by way of example, and are not intended to limit the disclosure to the illustrated components. More specifically, as discussed in more detail below, any of a plurality of components may be utilized at the host 102 and customer center 114.

FIG. 2 is a schematic diagram of an exemplary embodiment, illustrating functional components that may be utilized in a recording platform, such as a recording platform from FIG. 1. More specifically, the recording platform 110 may be configured to include a hosted storage system 210, a configuration manager 220, a license manager 230, a management system 240, a billing system 250, and a report server 260. The hosted storage system 210 includes recorders 211 configured to store communications data (e.g., telephone calls, messages, emails, screen captures, and/or other types of communications data) corresponding to remotely located contact center agents. Although two recorders 211 are illustrated in FIG. 2, the number of recorders may be greater or less, depending on a desired implementation.

The data recording platform 110 may be configured to perform one or more of the following functions (as will be explained in more detail further below): on-demand communications data recording initiated via a telephone; multi-tiered configuration, billing, licensing and reporting with programmable roles and permissions for application owners, network operators/service providers, affiliates or resellers and contact centers; a distributed multi-site, multi-tenanted recorder with system wide multi-role browser based administration; multi-tiered recording license aggregation across recorders; N+1 architecture with load balancing based on processor occupancy, dual local area networks (LANs), communications data recording with no single point of failure and “lights out” operation; duplicate media stream support for multiple switching environments; on-demand recorder configuration based on a contact center's subscribed-to services; centralized storage with managed storage partition allocation with first in first out (FIFO) overwrites and expansion capabilities; the ability to search and replay a recording through a browser; an automated mechanism for communications data recording export via a portable storage medium (e.g., DVD, CD); multi-tiered license ownership by a service provider including a right to deploy time restricted and on-demand/concurrent sessions; secure multi-tenanted, multi-tiered, real-time monitoring with traffic visualization and reporting, including graphing and trend analysis.

A service provider may be an entity that provides communication services to a customer and/or customer center 114. A service provider network may include a plurality of Points of Presence (POPs). A service provider may operate through tens, hundreds, or even thousands of POPs, depending on the regional, national or global reach of the service provider's network. The service provider may be configured to support interconnects to other networks including time division multiplexing (TDM), Internet Protocol (IP), and multi-protocol label switching (MPLS). The service provider may have multiple network operations centers (NOCs) that are usually co-located with larger POPs.

The hosted storage system 210 may be located at a service provider POP and may contain one or more recorders 211 that may be scaled through servers. One or more POPs may be supported by the hosted storage system 210. The hosted storage system 210 and the recorders 211 may be uniquely addressable. Operations such as recorder 211 configuration and software patch installation may be performed on the hosted storage system 210 and recorders 211.

Each recorder 211 may be capable of supporting a 100% duty cycle with continuous (e.g., 24 hours/day, 7 days per week, and 365 days per year) “lights out” operation and no single point of failure (SPOF). The hosted storage system 210 may be designed in an N+1 architecture where no recording is lost in the event of a single component failure. The hosted storage system 210 may be configured to support load balancing between recorders 211 based on processor occupancy to accommodate the differences in average talk time across multiple end-user contact centers and differences in machine capabilities and resources.

The server hardware for the recorders 211 may be network equipment building systems (NEBS) compliant. The hosted storage system 210 and the recorders 211 may provide service level agreement (SLA) conformance data based on uptime, availability and load. A recorder 211 may be configured to provide an alarm signal when resource usage (e.g., of memory, processor, input/output capacity) exceeds configurable thresholds and/or when the threshold is crossed as the resource returns to normal levels.

The hosted storage system 210 may support recording logic upgrades, operating system upgrades and/or other upgrades without impacting operational service. Dual LAN support may include automatic failover and fallback with management control and no loss of data. Communications data recordings may be accessible within a short period of time after an interaction has been completed.

Communications data recordings may be recorded by the recorders 211 and then transferred to a centralized storage resource without interrupting the data recording capabilities of the recorder 110. In the event that the centralized storage facility is not reachable, the recorders 211 may be capable of retaining the recording for a relatively long period of time.

The contact center 114 may be allocated a defined storage capacity that may be extended at additional charge or that may be over-written on a FIFO basis. Before a recording is started, a determination may be made as to whether the number of recording licenses for the contact center has been exceeded (e.g., across hosted storage systems 210 at multiple locations). If the threshold has been reached, the interaction may not be recorded and an alarm signal may be generated. A configuration option may prevent the interaction (e.g., telephone connection) from being setup if it cannot be recorded when no licenses are available.

The hosted storage system 210 and/or the recorders 211 may support a graceful shutdown mechanism that allows communications data in progress across recorders 211 to be completed before the system is out of service. The hosted storage system 210 and/or the recorders 211 may also support a hard shutdown mechanism.

A predetermined minimum number of simultaneous recording sessions per recorder 211 may be enabled along with transfers to a hosted storage system 210.

A single recorder 211 may support at least a portion of the capacity of a respective hosted storage system 210. The hosted storage system 210 may enable an increase or decrease in the number of servers accessing recorders 211 without impacting the operation of the hosted storage system 210 or the capability to display and change recorder 211 traffic distribution.

On-demand interaction recording may be initiated through a user pressing a programmable “hot key” to save interaction data. Interaction data and system events may be time-stamped and logged in such a way so as to be searchable and displayable through a browser in time-sequenced order. Additionally, recordings may be automatically deleted after a predetermined time period. Multiple configurable time periods for recording deletion may be supported so that a contact center may extend the retention period for an additional charge. An option to not delete recordings may be available with contact center billing based on storage allocation and usage. Storage allocation may be configurable and billable by a user (e.g., contact center, reseller, operator).

The management system 240 may provide a hierarchical view of hosted storage systems 210 and recorders 211. The management system 240 may provide a graphical user interface (GUI) that uses colors to represent the status of system components (e.g., red for out of service, yellow for entering or exiting service, and green for in-service). The GUI may be, as a nonlimiting example, browser-based.

The management system 240 may provide secure multi-access password-enabled login with programmable multi-role based permissions. As a nonlimiting example, a system administrator may have system wide permission to access hosted storage systems 210 and recorders 211 at multiple locations, whereas a site administrator at a POP may only be allowed access to a hosted storage system 210 and recorders 211 at a respective location. A site operator may, for example, have permission to change the service readiness state of the hosted storage system 210 and to view alarm signals of the hosted storage system 210 at a particular location. The management system 240 may enable adding, deleting, and maintaining resources allocated to operators, affiliates and contact centers.

As discussed above, the management system 240 may be designed with an N+1 architecture with no operational impact if a management system 240 component fails. The management system 240 may support operating system and application software upgrades without impacting available storage system 210 functionality.

The management system 240 may provide multi-level alarm severity with configurable alarm signal text. An alarm signal may exclude, as a nonlimiting example, hexadecimal and/or numeric codes. Further, an alarm signal may indicate a certain alarm level from among several possible levels. Alarm signals may be labeled in such a way that identifies the cause or severity of an alarm. As an additional nonlimiting example, an alarm signal may be labeled as a warm, hot, or a restored threshold alarm.

The management system 240 may provide virtual storage management with support for NAS (network access server) and SAN (storage area network) storage. Furthermore, the management system 240 may enable storage expansion capability for a hosted storage system 210 without impacting functionality of the hosted storage system 210. The management system 240 may also enable reconfiguring hosted storage system 210 resources to minimize the number of storage components utilized.

Threshold conditions, charts, and reports on recorder utilization may be used to understand traffic patterns across shared recording and storage resources. Access to reports may be restricted and may be password protected. Business rules may be used to determine an appropriate action to be taken when an exception condition occurs, such as to automatically allocate more storage resources or to not record or enable an interaction.

The configuration manager 220 may be operable to configure the recorders 211 based on the services that a subscriber center has subscribed (e.g., 100% recording, selective recording of communications data, etc.). Similarly, the configuration manager 220 may be configured enable the recording of services to be turned on or off by authorized users. A default level of recording services may be configured via the configuration manager 220. Recording capacity may be re-configured, but over-capacity subscription may be prevented (e.g., by not allocating more ports than the number of ports available in a total hosted storage system 210). The configuration manager 220 may also save and restore local and remote configurations for the hosted storage system 210.

Similarly, the configuration manager 220 may be designed with an N+1 architecture that helps to prevent an interruption in recording services in case of a failure. The configuration manager 220 may also support operating system and application software upgrades without an interruption in recording services. The configuration manager 220 may be configured to provide a log of configuration changes to the hosted storage system 210 and/or the recorders 211. The configuration manager 220 may also be configured to provide a GUI that illustrates resource usage (e.g., of a server, a recorder, and/or a network, etc.).

Due to the large amount communications data that is routed through the data storage system 200, in at least one exemplary embodiment, it may be desirable to only record subscriber communications data. As such, one or more of the following features and functionality may be supported by the data storage system 200: active (but passive and non-intrusive) duplicate signaling and media stream from the softswitch/PBX; a business-to-business session initiation protocol (SIP) trunk through which interaction signaling and media are routed by a softswitch when communications data are to be recorded; multiple switching environments and services, such as, for example, CS2K communication server 2000 (CS2K) and recording hosted interactive voice response (IVR); active duplicate signaling and media stream through integration with multiple (SBC) session border controller vendors, media servers, and/or handsets that duplicate contact center communications data; multiple switching environments and services may be supported, such as, for example, session border controller (SBC) and recording hosted contact center, Communications Assistance for Law Enforcement Act (CALEA), etc.; active-active signaling may be used where, as a nonlimiting example, service provider's SBC or media server vendor does not duplicate a media stream; Wav file integration from a third party media server with recording capability; and softswitch/PBX.

A report server 260 may provide various reports on the hosted storage system 210. These reports may be generated, as a nonlimiting example, in a scheduled manner, or on an ad-hoc basis. A report may be accessed through a browser based GUI and may be output via, for example, being printed or exported electronically (e.g., via email). System data may be reported in tabular and/or graphical format. The report server 260 may be configured to provide information on resource utilization and traffic patterns. The information provided by the reports server 260 may be sorted by criteria such as contact center, reseller, and/or network operator. The report server 260 may also provide real-time and/or historical traffic visualization across the hosted storage system 210 and recorders 211.

The report server 260 may be configured to support a plurality of user roles including multi-tiered views for service reports based on the permission granted to the requesting user. As a nonlimiting example, a contact center user may be provided with data corresponding to the user's contact center. On the other hand, a reseller may be provided with data corresponding to the contact centers purchasing services from the reseller. Further, a network owner or operator may be able to access consolidated data corresponding to multiple resellers (in addition to the data that is accessible to resellers).

The report server 260 may be configured to provide reports for contact centers, resellers, network operators, and/or application owners. These reports may include time interval based reporting in tabular format and/or graphs for trend analysis. Contact center reports may include information such as, for example, the number of calls recorded and/or the number of concurrent recording sessions. Reseller reports may include information identifying, for example, resource utilization by contact centers. Network operator reports may include information identifying, for example, resource utilization by contact centers and resellers. Application owner reports may include information identifying, for example, resource utilization by contact centers, resellers and network operators.

Communications data may be tagged to stored communications data to allow the stored communications data to be searched based on a desired search parameter. The tagging data may identify, as a nonlimiting example, time of day, interaction length, dialed number, extension number, and/or calling party number, among other information. Range-based searches may also be supported by the tagging data.

Communications data retrieved from storage may be displayed in a browser-based GUI. Therefore, additional software might not necessarily be required for a computer performing the search and presentation of communications data. A list of available or retrieved recordings may be displayed and sorted based on starting times of the communications data. Playback features for communications data retrieved from storage may include play, rewind, fast-forward, pause and resume. Communications data may also be exported to a DVD or CD, and/or may be emailed to a desired email address.

The hosted storage system 210 may be configured to support various capacity requirements with no increase in resource (e.g., memory) allocation. Login, password and authentication in connection with the hosted storage system 210 may meet the requirements for the payment card industry (PCI) audit specification. As a nonlimiting example, passwords may be stored in an encrypted format and may be changed by respective users.

Similarly, the hosted storage system 210 may be functional in various major European, Asian and American countries. Testing in countries such as the United Kingdom, Finland, the United States, and Japan may be performed to demonstrate international functionality. A plurality of reading languages may be supported. Software used in the hosted storage system 210 may support double byte characters so that languages such as Japanese may be supported. Strings within software may be separated from the code to help enable multiple language functionality.

Similarly, the hosted storage system 210 may function in conjunction with a plurality of country-specific operating system variants (e.g., a Japanese version of a U.S. operating system). Installation of software at a contact center for enabling hosted storage of communications data may be simple and may require only a small number of steps. A basic level understanding of computers may be sufficient to install and use the software (e.g., the ability to navigate GUIs, to use CD-ROMs, etc.).

Additionally, the recording platform 110 may include speech analytics logic, which may be utilized for speech recognition and/or analyzing the content of recognized speech. Nonlimiting examples of such functionality is disclosed in U.S. application Ser. No. 11/540,281 (Attorney Docket No. 762301-1870), entitled “Speech Analysis Using Statistical Learning” and U.S. application Ser. No. 11/540,332 (Attorney Docket No. 762301-1870), entitled “Multi-Pass Speech Analytics,” both of which are incorporated by reference in their entireties. Similarly, while this logic may be present in the recording platform, this is also a nonlimiting example, as the speech analytics logic may reside elsewhere on the network, whereas the recording platform 110 may reside at an enterprise and/or elsewhere on the network.

FIG. 3 is an additional exemplary embodiment of a recording platform, illustrating logical components that may be utilized. Although a wire-line recording platform 110 is illustrated, this discussion can be applied to wireless devices, as well. Generally, in terms of hardware architecture, as shown in FIG. 3, the recording platform 110 may include a processor 382, a memory component 384 (which may include volatile and/or nonvolatile memory components), a display interface 394, a data storage component 395, one or more input and/or output (I/O) device interface(s) 396, and/or one or more network interface 398 that are communicatively coupled via a local interface 392. The local interface 392 can include, for example but not limited to, one or more buses or other wired or wireless connections. The local interface 392 may have additional elements, which are omitted for simplicity, such as controllers, buffers (caches), drivers, repeaters, and receivers to enable communications. Further, the local interface may include address, control, and/or data connections to enable appropriate communications among the aforementioned components. The processor 382 may be a device for executing software, particularly software stored in the memory component 384.

The processor 382 can be any custom made or commercially available processor, a central processing unit (CPU), an auxiliary processor among several processors associated with the recording platform 110, a semiconductor based microprocessor (in the form of a microchip or chip set), a macroprocessor, or generally any device for executing software instructions.

The memory component 384 can include any one or combination of volatile memory elements (e.g., random access memory (RAM, such as DRAM, SRAM, SDRAM, etc.)) and/or nonvolatile memory elements (e.g., ROM, hard drive, tape, CDROM, etc.). Moreover, the memory component 384 may incorporate electronic, magnetic, optical, and/or other types of storage media. One should note that some embodiments of the memory component 384 can have a distributed architecture (where various components are situated remotely from one another), but can be accessed by the processor 382.

The software in memory component 384 may include one or more separate programs, each of which includes an ordered listing of executable instructions for implementing logical functions. In the example of FIG. 3, the software in the memory component 384 may include an operating system 399 and recording logic 388. The operating system 386 may be configured to control the execution of other computer programs and provides scheduling, input-output control, file and data management, memory management, and communication control and related services.

A system component and/or module embodied as software may also be construed as a source program, executable program (object code), script, or any other entity comprising a set of instructions to be performed. When constructed as a source program, the program is translated via a compiler, assembler, interpreter, or the like, which may or may not be included within the memory component 384, so as to operate properly in connection with the operating system 386.

The Input/Output devices that may be coupled to system I/O Interface(s) 396 may include input devices, for example but not limited to, a keyboard, mouse, scanner, microphone, etc. Further, the Input/Output devices may also include output devices, for example but not limited to, a printer, display, speaker, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a media duplication system, a router, etc.

Additionally included are one or more network interfaces 398 for facilitating communication with one or more other devices. More specifically, a network interface 398 may include any component configured to facilitate a connection with another device. While in some embodiments, among others, the recording platform 110 can include a network interface 398 that includes a Personal Computer Memory Card International Association (PCMCIA) card (also abbreviated as “PC card”) for receiving a wireless network card, however this is a nonlimiting example. Other configurations can include the communications hardware within the computing device, such that a wireless network card is unnecessary for communicating wirelessly. Similarly, other embodiments include network interfaces 398 for communicating via a wired connection. Such interfaces may be configured with Universal Serial Bus (USB) interfaces, serial ports, and/or other interfaces.

If recording platform 110 includes a personal computer, workstation, or the like, the software in the memory component 384 may further include a basic input output system (BIOS) (omitted for simplicity). The BIOS is a set of software routines that initialize and test hardware at startup, start the operating system 386, and support the transfer of data among the hardware devices. The BIOS is stored in ROM so that the BIOS can be executed when the recording platform 110 is activated.

When recording platform 110 is in operation, the processor 382 may be configured to execute software stored within the memory component 384, to communicate data to and from the memory component 384, and to generally control operations of the recording platform 110 pursuant to the software. Software in memory, in whole or in part, may be read by the processor 382, perhaps buffered within the processor 382, and then executed.

One should note that while the description with respect to FIG. 3 includes a recording platform as a single component, this is a nonlimiting example. More specifically, in at least one embodiment, the recording platform 110 can include a plurality of servers, personal computers, recorders, and/or other devices. Similarly, while the recording logic 388 and the operating system 399 are each illustrated in FIG. 3 as single software components, this is also a nonlimiting example. In at least one embodiment, the recording logic 388 may include one or more components, embodied in software, hardware, and/or firmware. Similarly, the operating system 399 may include one or more logical components. Additionally, while the routing recording logic 388 and the operating system 399 are depicted as residing on a single computing device, such as the recording platform 110 may include one or more devices, the recording logic 388 may include one or more components residing on one or more different devices.

Similarly, while the discussion with regard to FIG. 3 refers to a recording platform 110, the above description may be applied to other components discussed herein. More specifically, the server 104, 116, the computing device 106, 118, the communications device 108,120, components 210-260, and/or other components may include similar elements and/or operate similarly.

FIG. 4 is a diagram illustrating an exemplary embodiment of a multi-tiered service provider configuration, such as may be utilized in the network from FIG. 1.

The exemplary embodiment of FIG. 4 includes an application owner 410, network owners 420, resellers 430, and contact centers 440. An application owner 410 may own one or more applications associated with a recording platform and can provide network owners 420 with the applications configured to enable storage and retrieval of communications data (e.g., telephone calls or messages, e-mails, and screen captures) corresponding to remotely located contact center agents. The network owners 420 (e.g., service providers) may license and/or sell the applications to the resellers 430 and/or the contact centers 440. The resellers 430 that purchase and/or license the applications from network owners 420 may resell them to contact centers 440.

The network owners 420 may offer services such as hosted Internet Protocol Private Branch Exchange (IP PBX), hosted contact routing, hosted automatic contact distributor (ACD), and hosted interactive voice response (IVR) to contact centers. The network owners 420 may be offered systems and methods for hosted storage of contact center interactions as an add-on revenue-generating feature to these existing services.

Hosted storage of communications data may support branding for the application owners 410, the network owners 420, and the resellers 430. A network owner 420 (or other entity) may re-brand and resell services that have a multi-tiered service management model. The multi-tiered model may extend across licensing, provisioning, reporting, and resource usage of the service. In some deployments, some of these tiers may be combined (e.g., the network owner 420 owning the application).

In some embodiments, the hosted recording of communications data may be included as an add-on feature of services provided by a network owner 420. The add-on feature may be provisioned by the network owner 420 or by the reseller 430. As a nonlimiting example, if the network owner 420 or the reseller 430 configures a contact center for hosted PBX services, the network owner 420 and/or the reseller 430 may select a GUI option (e.g., by checking an applicable selection box) to enable full-time or on-demand recording (which could result in the contact center 114 becoming provisioned by the reseller).

Hosted contact storage may be provided based on one or more of the following pricing and billing features: billing based on a predetermined term (e.g., single or multi-year contracts); billing with no predetermined term (e.g., pay as you go); a periodic fee (e.g., monthly) per telephone; a license that enables up to a predetermined number of concurrent recording sessions; a fee charged based on a number of contact center agents using the service during a predetermined time period (e.g., up to 50 agents for 1 year or up to 100 agents for 3 years); billing may be monthly, annual or based on any desired time schedule; a partner may purchase licenses to use hosted storage and may sell these licenses to respective contact centers; hosted storage usage licenses may be aggregated across hosted storage systems and recorders at various locations; per-minute billing options may be offered; billing for lengths of time that communications data are stored; billing for amount of storage used; billing for providing copies of stored communications data (e.g., via DVDs or CDs); billing for external interfaces that integrate with the network owner's 420 billing system.

FIG. 5A is a schematic diagram of an exemplary embodiment of a network configuration, illustrating a distributed customer center configuration, similar to the diagram from FIG. 1. The embodiment of FIG. 5A includes customer centers 114 and a host 104. A customer center 114 includes one or more communications device 120. The communications device 120 may comprise, for example, a customer center computer, a customer center telephone, and/or other components. The host 104 includes a hosted storage system 210. The communications device 120 and the hosted storage system 210 are coupled via the network 100. The hosted storage system 210 stores communications data corresponding to an agent using an agent communications device 120.

FIG. 5B is a schematic diagram depicting an exemplary embodiment of a network configuration, illustrating a distributed recording configuration. More specifically, the exemplary embodiment of FIG. 5B includes a customer center 114 and a host 104. The customer center 114 includes an agent computing device 120, a communications device 120, and a screen recorder 526. The host 104 includes an audio recorder 527, which may be configured stores telephone interaction data corresponding to the telephone 328. The telephone interaction data may be provided to a recorder 211 by, for example, a telephone switch located at the host 104 and coupled to a communications device 120 (e.g., see FIGS. 1 and 2). The screen recorder 526 stores computer data (e.g., screen capture data, e-mails, etc.) corresponding to the agent computer 321.

FIG. 5C is a schematic diagram of an exemplary embodiment of a network configuration, illustrating a plurality of recording platforms at a host. As illustrated in the nonlimiting example of FIG. 5C, at least one exemplary embodiment may include a customer center 114 and a host 104. The customer center 114 includes an agent computing device 118 and a communications device 120. The host 104 may be configured to include a screen recorder 536 and an audio recorder 537. The audio recorder 537 may be configured to record audio interaction data corresponding to the communications device 120. The audio data may be provided to the audio recorder 537 by, as a nonlimiting example, a telephone switch located at the host 104, and coupled to the communications device 120. The screen recorder 536 may be configured to record computer data (e.g., screen capture data, e-mails, video, etc.) corresponding to the agent computing device 118. The computer data may be provided to the screen recorder 536 by, as a nonlimiting example, a server that is located at the host 104, and that is coupled to the agent computing device 118 via the network 100.

One should note that in this nonlimiting example, as well as other nonlimiting examples in this disclosure, computer data and audio data might be received as one or more data streams of the same communication. More specifically, in at least one exemplary embodiment, the computing device 118 may be configured as a video/image-enabled communications device, such as a soft phone. In such a configuration, visual data (e.g., video, image, graphics, animation, etc.) as well as audio data may be sent and received. In such a configuration the screen recorder 536 may be configured to receive the visual data, while the audio recorder 537 may record the audio data. Similarly, in some configurations, as discussed herein, may store the visual data with the audio data.

FIG. 5D is an exemplary embodiment of a network configuration, illustrating a plurality of server components at a host. As illustrated in the nonlimiting example of FIG. 5D, the customer center 114 may be coupled to the host 104 via the network 100. The customer center 114 may include one or more communications devices 120. The host 104 may include a screen recorder 543, a management server 545, a communications database 546, an audio recorder 547, an application server 548, an archive server 549, and/or an integration server 550. The host 104 may include fewer or additional devices depending on a desired implementation.

The archive server 549 may be configured to store archived communications data (e.g., audio, video, image, and/or other data that was previously recorded). The communications database 546 may be configured to contain detailed information (e.g., agent name, account information, timing information, etc.) corresponding to communications data stored in the audio recorder 547 and/or the archive server 549. The application server 548 provides the agent interaction device 541 with data from the communications database 546, the audio recorder 547, and the archive server 549 (e.g., upon request).

The audio recorder 547 may be controlled by a telephony-based control protocol and/or by the integration server 550. The audio recorder 547 may be configured to provide communications data to an communications database 546 that the customer centers 114 can access via the application server 548. Similarly, in some exemplary embodiments, each customer may have their own specified database at the host 104 and/or at the customer center 114.

A customer center 114 may include a mechanism to download communications data stored at the host 104. This mechanism may be used where the host 104 delivers recording and basic replay functionality. If a customer center administrator desires advanced features, the customer center administrator may purchase enhanced functionality provided by application servers located at the host 104.

Depending on the requirements for recording a large volume of visual data (and the particular configuration), a screen recorder 543 may be located at the customer center 114 so that transporting the visual data to the screen recorder 543 is more efficient. Potentially, if the host 104 is a network service provider, visual data may be transmitted to a screen recorder 543 located at the host 104. Similarly, an archive server 549 may be configured to store communications data received from one or more recorders. A host 104 may be configured to provide an archive server 549 as a managed service to a customer center administrator and/or may enable the customer center administrator to utilize a local archive server.

The use of a customer center archive server may allow a customer center 114 to retrieve communications data from the host 104 and store this data at the customer center 114. This could also enable a customer center administrator to maintain control of the local communications data and transition more easily to another host 104. A customer center administrator may take ownership of both an communications database and an archive server that are located at the customer center 114, since the customer center administrator may regard these components as important assets.

A management server 545 may be configured to provide a tiered level of management functionality. As a nonlimiting example, a customer center administrator may decide which customer center communications device extensions to record and may therefore access the management server 545 to configure a storage system accordingly. The management server 545 may be configured to provide a customer center administrator with graphical user interfaces (GUIs) that enable the customer center administrator to view and configure the customer center's storage functionality, as permitted by the terms of an agreement between the customer center administrator and the host 104.

Further, a host administrator may access the management server 545 to determine and/or configure storage functionality offered to various customer center administrators. Between the host 104 and the customer center administrator, there may be further levels of host service resellers. The management server 545 may provide the resellers with respective GUIs and configuration functionality that correspond to the respective services the resellers have purchased. Although shown separately, a management server 545 may be integrated into an application server such as application server 548).

An integration server 550 may exist at several levels in a hosting environment. The integration server 550 may be configured to interface with a computer telephony integration (CTI) or other system that is configured to offer agent interaction information for tagging recorded communications data. The integration server 550 can receive the agent interaction information and then use the agent interaction information to tag respective recordings. As a result, the customer center administrator corresponding to stored communications data may be identified and security and access may be implemented accordingly.

A customer center administrator may request detailed tagging in line with that which could be achieved at a customer center. This may involve a host device communicating with a customer center administrator's back-end systems to collect agent interaction information to be used for tagging recorded communications data. Because there may be a desire to communicate the agent interaction information securely into the hosting environment, a proxy integration server located at the customer center 114 may be used to communicate with the integration server 550.

FIG. 6A is a schematic diagram of an exemplary embodiment of a network configuration, illustrating a plurality of connections between components of a host and a customer center. As illustrated in the nonlimiting example of FIG. 6A, a customer center 114 and a host 104 may be included. The customer center 114 may be configured to include an agent computing device 118 and a communications device 120. The host 104 may include includes a host server 613, a screen recorder 616, an audio recorder 617, an application server 618, and a switching component 619. The audio recorder 617 stores communications data corresponding to interactions occurring via the communications device 120. The switching component 619 may be configured to provide telephone messages to the communications device 120 and to the audio recorder 617. The screen recorder 616 may be configured to record visual data (e.g., screen capture data, video data, e-mails, etc.) corresponding to the agent computing device 118. The host server 613 provides the visual data to the screen recorder 616. The host server 613 is also configured to provide computer applications to the agent computing device 118. The application server 628 may retrieves communications data stored in the screen recorder 616 and the audio recorder 617, and provides them to the agent computing device 118 and/or to another communications device located at the customer center 114. The agent computing device 118 and the application server 618 are coupled via the network 100.

FIG. 6B is a schematic diagram of an exemplary embodiment of a network configuration, illustrating a plurality of connections between components of a host and a customer center with a distributed recording architecture. As illustrated in the nonlimiting example of FIG. 6B, a customer center 114 and a host 104 may be included. The customer center 114 includes an agent computing device 118, a screen recorder 626, and a communications device 120. The host 104 may include an audio recorder 627, an application server 628, and a switching component 619. The audio recorder 627 may be configured to store interaction data occurring via the communications device 120 and/or computing device 118. The telephone switch 629 may be configured to provide the telephone interaction data to the communications device 120 and to the audio recorder 627.

The screen recorder 626 may be configured to record computer interaction data (e.g., screen capture data, e-mails, etc.) corresponding to the agent computing device 118. The application server 628 may be configured to retrieve communications data stored at the audio recorder 627, and provides this data to the agent computing device 118 or to another device at the customer center 114. The agent computing device 118 and the application server 628 are coupled via the network 100.

FIG. 7A is a schematic diagram of an exemplary embodiment of a network configuration, illustrating a plurality of connections between components of a host and a customer center, including a contact database. The nonlimiting example of FIG. 7A includes a customer center 114 and a host 104. The customer center 114 includes communications data device 701. The host 104 includes an contact database 706, a recorder 110, an application server 708, and an archive server 709. The agent interaction device 701 may be coupled to the application server 708 via the network 100. The archive server 709 stores archived communications data (e.g., telephone and/or computer interaction data). The communications database 706 may contain detailed information (e.g., agent name, account information, timing information, etc.) corresponding to communications data stored in the recorder 110 and/or the archive server 709. The application server 708 may be configured to provide the agent communications device 120 with data from the communications database 706, the recorder 110, and the archive server 709.

FIG. 7B is a schematic diagram of an exemplary embodiment of a network configuration, illustrating a plurality of connections between components of a host and a customer center, including a contact database at a customer center. The nonlimiting example of FIG. 7B includes a customer center 114 and a host 104. The customer center 114 may include agent communications device 120, an contacts database 716, an application server 718, and an archive server 719. The host 104 may include a recorder 110. The archive server 719 may be configured to store archived communications data (e.g., telephone and/or computer interaction data). The communications database 716 contains detailed information (e.g., agent name, account information, timing information, etc.) corresponding to communications data stored in the recorder 110 and/or the archive server 719. The application server 718 provides the agent interaction device 711 with data from the communications database 716, the recorder 110, and the archive server 719 (e.g., upon request).

FIG. 8 is a schematic diagram illustrating an exemplary embodiment of a network configuration, illustrating a plurality of integration servers in a distributed recording environment. As illustrated, the nonlimiting example of FIG. 8 includes a customer center 114 and a host 104. The customer center 114 includes a screen recorder 806 and an integration server 808. The host 104 includes an audio recorder 807 and an integration server 809. The integration server 808 and the integration server 809 receive tagging data from respective sources and use the tagging data to tag communications data stored in the screen recorder 806 and the audio recorder 807, respectively. The tagging data may identify, for example, the timing of an agent interaction, the corresponding agent and/or corresponding account information, etc.

FIG. 9 is a flowchart illustrating an exemplary embodiment of a process that may be utilized for transmitting data to a customer center, such as in the network from FIG. 1. As illustrated, a hosted storage system (e.g., system 210) receives communications data corresponding to a customer center agent working at a remotely located customer center 114 (block 901). The communications data may encode for example, a communication (e.g., a conversation, screen capture data, an e-mail, etc.). The hosted storage system can store the communications data (block 902). The hosted storage system can receive a request for the communications data from the remotely located customer center (block 903). The hosted storage system can transmit the communications data to the remotely located customer center (block 904).

FIG. 10 is a flowchart illustrating an exemplary embodiment of a process that may be utilized for providing a copy of captured data to a customer center, similar to the diagram from FIG. 9. As illustrated in the nonlimiting example of FIG. 10, a hosted storage system may be configured to store audio data (e.g., encoding data associated with a communication) corresponding to a customer center agent session (block 1001). The hosted storage system may be configured to store screen capture data corresponding to the customer center agent session (block 1002). The hosted storage system provides a copy of the recorded audio data to the customer center 114 (block 1003). The hosted storage system can also provide a copy of the recorded screen capture data to the customer center (block 1004).

FIG. 11 is a flowchart illustrating an exemplary embodiment of a process that may be utilized for retrieving captured data from a customer center, similar to the diagram from FIG. 10. As illustrated in the nonlimiting example of FIG. 11, a hosted storage system may be configured to store audio data corresponding to a customer center agent session (block 1102). A screen recorder (e.g., screen recorder 526) stores screen capture data corresponding to the customer center agent session. The hosted storage system provides a copy of the recorded audio to the customer center (block 1103). A customer center device retrieves a copy of the recorded screen capture data from the customer center storage system (block 1104).

It should be noted that any process descriptions or blocks in flowcharts should be understood as representing modules, segments, or portions of code which include one or more executable instructions for implementing specific logical functions or steps in the process. As would be understood by those of ordinary skill in the art of the software development, alternate embodiments are also included within the scope of the disclosure. In these alternate embodiments, functions may be executed out of order from that shown or discussed, including substantially concurrently or in reverse order, depending on the functionality involved.

It should be noted that a customer center may include, but is not limited to, outsourced contact centers, outsourced customer relationship management, customer relationship management, voice of the customer, customer interaction, contact center, multi-media contact center, remote office, distributed enterprise, work-at-home agents, remote agents, branch office, back office, performance optimization, workforce optimization, hosted contact centers, and speech analytics, for example.

Additionally included in this disclosure are embodiments of integrated workforce optimization platforms, as discussed in U.S. application Ser. No. 11/359,356, filed on Feb. 22, 2006, entitled “Systems and Methods for Workforce Optimization,” which is hereby incorporated by reference in its entirety. At least one embodiment of an integrated workforce optimization platform integrates: (1) Quality Monitoring/Call Recording-voice of the customer; the complete customer experience across multimedia touch points; (2) Workforce Management—strategic forecasting and scheduling that drives efficiency and adherence, aids in planning, and helps facilitate optimum staffing and service levels; (3) Performance Management—key performance indicators (KPIs) and scorecards that analyze and help identify synergies, opportunities and improvement areas; (4) e-Learning—training, new information and protocol disseminated to staff, leveraging best practice customer interactions and delivering learning to support development; and/or (5) Analytics—deliver insights from customer interactions to drive business performance. By way of example, the integrated workforce optimization process and system can include planning and establishing goals—from both an enterprise and center perspective—to ensure alignment and objectives that complement and support one another. Such planning may be complemented with forecasting and scheduling of the workforce to ensure optimum service levels. Recording and measuring performance may also be utilized, leveraging quality monitoring/call recording to assess service quality and the customer experience.

The embodiments disclosed herein can be implemented in hardware, software, firmware, or a combination thereof. At least one embodiment, disclosed herein is implemented in software and/or firmware that is stored in a memory and that is executed by a suitable instruction execution system. If implemented in hardware, as in an alternative embodiment embodiments disclosed herein can be implemented with any or a combination of the following technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks might occur out of the order and/or not at all. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

One should also note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

What is claimed is:

1. A method for providing interaction data services, comprising:
receiving communications data at a host, wherein the communications data corresponds to a communication involving a customer center agent at a customer center located remotely from the host;
storing the data at the host; and
providing the data to a device located at the customer center.

2. The method of claim 1, wherein the communications data includes at least one of the following: audio data and visual data.

3. The method of claim 2, wherein the communications data includes audio data and visual data.

4. The method of claim 3, further comprising correlating the audio data with the visual data.

5. The method of claim 3, wherein the audio data is stored at the customer center and the visual data is stored at the host.

6. The method of claim 3, wherein the audio data is stored at the host and the visual data is stored at the customer center.

7. The method of claim 1, wherein the host is configured to provide interaction data services for a plurality of customer centers.

8. A system located at a host, comprising:
memory;
software stored in the memory; and
a processor;
wherein the software is configured to instruct the processor to cause communications data to be stored at the host, wherein the communications data corresponds to a communication involving a customer center agent at a customer center located remotely from the host; and
wherein the software is configured to instruct the processor to cause the communications data to be delivered to a device located at the customer center.

9. The system of claim 8, further comprising means for storing, at the host, communications data corresponding to the customer center agent.

10. The system of claim 8, wherein the communications data includes at least one of the following: audio data and visual data.

11. The system of claim 10, wherein at least one of the following: the audio data is stored at the customer center and the visual data is stored at the host.

12. The system of claim 10, wherein the audio data is stored at the host and the visual data is stored at the customer center.

13. The system of claim 8, wherein the system is configured to provide the communications data to a device located at the customer center.

14. The system of claim 8, wherein the host is configured to communicate with a plurality of customer centers.

15. A computer readable storage medium for storing customer center communications data, comprising:
logic configured to receive communications data at a host, wherein the communications data corresponds to a communication involving a customer center agent at a customer center located remotely from the host, wherein the communications data includes audio data and visual data;
logic configured to record the audio data at the host;
logic configured to provide the audio data to a device located at the customer center;
logic configured to record, at the host, the visual data; and
logic configured to correlate the visual data with the audio data.

16. The computer readable storage medium of claim 15, wherein the visual data includes at least one of the following: computer a screen capture and an electronic message.

17. The computer readable storage medium of claim 15, wherein the host is configured to communicate with a plurality of customer centers.

18. The computer readable storage medium of claim 15, wherein the logic to record audio data is configured with failover recording functionality.

19. The computer readable storage medium of claim 15, wherein the logic to record visual data is configured with failover recording functionality.

20. The computer readable storage medium of claim 15, wherein the host is configured to communicate with a plurality of customer centers.
